(19) United States
(12) Patent Application Publication
(10) Pub. No.: US 2011/0046986 A1
(43) Pub. Date: Feb. 24, 2011

(54) Method and apparatus for insurance vertification

(75) Inventors: Tim Thomas, Elizabethtown, KY (US); Arnie Lambert, Hodgenville, KY (US); Gerald Hignite, Elizabethtown, KY (US)

Correspondence Address: STOCKWELL & SMEDLEY, PSC, 861 CORPORATE DRIVE, SUITE 200, LEXINGTON, KY, 40503, US

(73) Assignee: Gravel Road Innovations, LLC, Hodgenville, KY (US)

(21) Appl. No.: 12/583,258

(22) Filed: Aug. 18, 2009

(51) Int. Cl. G06Q 40/00; G08G 1/00

(52) U.S. Cl. 705/4; 340/902

(57) ABSTRACT

A system and device provides an indication signal perceivable by an observer of a vehicle as to whether that vehicle is covered by a valid insurance policy. A database of policy information is consulted by a control system that, in turn, generates a control signal that is transmitted to an indicator device on vehicle to control whether the indicator device signals that a valid insurance policy is in place or is not.

### BACKGROUND OF THE INVENTION

1. Field of the Invention

The present invention relates to law enforcement and, more particularly, to insurance verification.

2. Description of Related Art

Many states have enacted laws relating to mandatory insurance for vehicles that use the highways and roads for travel. Some of these laws pertain to minimum amounts of coverage and similar details while other laws simply mandate that all vehicles must be covered by an active insurance policy. In some states there are very few verification methods and therefore a number of uninsured motorists may be present even though it is against the law. Other states may require that proof of insurance must be provided before a car receives its state or local registration papers.

Even when proof of insurance is required, some people choose to circumvent the law as well. For example, one common technique is for a person to purchase insurance, then title and register their vehicle, and then simply cancel the insurance policy. This procedure can then be repeated each time the vehicle's registration is to be renewed.

Accordingly, despite the best efforts of officials there can still be a number of undiscovered uninsured drivers on the road at any time. It is not until a police officer performs a traffic stop that an uninsured motorist may be caught. However, making a traffic stop requires the officer to have some reasonable grounds for stopping a driver and because there is no readily recognizable sign that a driver has no insurance, catching uninsured motorists requires waiting until their driving habits lead to a traffic stop.

While the information about the status of insurance policies is theoretically available on each insurance company's computer, there is currently no way to aggregate this information in a way that policy information is available to law enforcement officers in a timely fashion. Thus, there remains an unmet need for a system and method for alerting law enforcement personnel that a vehicle is uninsured and to do so with information that is current.

### BRIEF SUMMARY OF THE INVENTION

Embodiments of the present invention relate to a system and device that provides an indication signal perceivable by an observer of a vehicle as to whether that vehicle is covered by a valid insurance policy. A database of policy information is consulted by a control system that, in turn, generates a control signal that is transmitted to an indicator device on vehicle to control whether the indicator device signals that a valid insurance policy is in place or is not.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF DRAWINGS

Various aspects of the invention are illustrated by way of example, and not by way of limitation, in the accompanying drawings, wherein:

FIG. 1 illustrates a system diagram of a system for verifying insurance in accordance with the principles of the present invention.

FIG. 2 illustrates a block diagram of an apparatus for verifying insurance in accordance with the principles of the present invention.

FIG. 3 is a flowchart of a portion of a method of verifying insurance in accordance with the principles of the present invention.

FIG. 4 is a flowchart of a portion of a method of verifying insurance in accordance with the principles of the present invention.

### DETAILED DESCRIPTION OF INVENTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

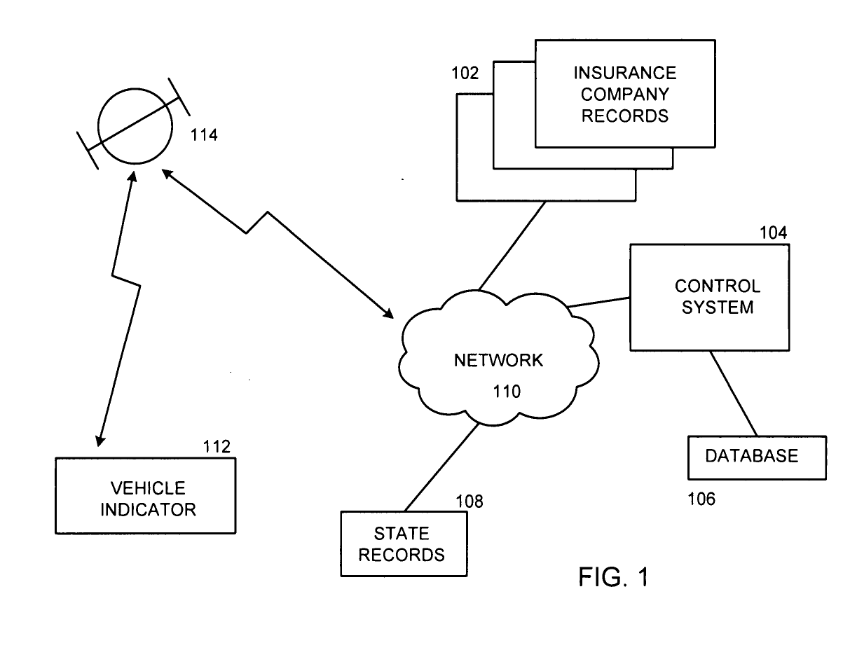

FIG. 1 illustrates a system diagram of a system for verifying insurance in accordance with the principles of the present invention. In the system of FIG. 1, there is a vehicle indicator 112 that provides some type of indication to law enforcement personnel that the vehicle to which the indicator 112 is attached is not covered under a valid insurance policy. The indication signal provided by the indicator 112 is beneficially visible both in daylight conditions and nighttime conditions. For example, a high intensity LED provides sufficient brightness to be seen in almost any conditions. An alternative is for the indication signal to be at a radio frequency that is easily detected by an appropriately tuned receiver at short distances such as, for example, 20 feet or less. One of ordinary skill will recognize that the two types of indication signals can be used in combination as well. In operation, the indication signal of the indicator 112 has different states that indicate whether or not a valid insurance policy is in place that covers the vehicle to which the indicator is attached.

Proper operation of the indicator 112 relies on other entities to store information and to provide control signals to the indicator 112. The example system of FIG. 1 includes a control system 104 that manages a database 106. The control system 104 can be a web server connected to a network 110 such as the Internet but may also be a server using more specialized and proprietary protocols to perform its functions. Through the network 110, the control system 104 can communicate with insurance companies to have access to the company records 102. This communication can take place in a variety of different ways without departing from the scope of the present invention. For example, the insurance companies may initiate a session with the control system 104 and provide their latest records. In addition, an operator of the control system 104 may be provided periodic access to the company records 102 in order to retrieve the latest records. Regardless of the specific methods used, the control system 104 manages the database 106 which stores information about whether a particular vehicle has a valid, in-force, insurance policy.

The control system 104 may also include a transmit function to communicate with a broadcast transmitter such as, for example, the satellite 114 of FIG. 1 which transmits a control signal to the vehicle indicator 112. Depending on the control signal, the indicator 112 signals that there is an insurance policy in place or there is not. Embodiments of the present invention contemplate a satellite based system to easily provide significant coverage over most of the United States. Similarly, other large geographic regions can be covered by a properly placed satellite as well. In embodiments implemented on a more local scale, the broadcast transmitter that sends the control signal need not be a satellite but may be a cellular or radio transmitter, a pager system, or a wireless network capable of reaching the boundaries of the region being covered.

In addition to insurance records 102, a vehicle also has associated registration and title information usually maintained by a state or local government agency. This data could be integrated within the database 106 as well so that the vehicle indicator 112 could also indicate whether the cars registration was valid or invalid.

The database 106 can be used to store a variety of different data that simplifies the operation of the system of FIG. 1. For example, each vehicle indicator 112 can have an associated set of records related to its vehicle and the owner of that vehicle. The associated set of records may include the vehicle identification number (VIN), the active/inactive dates of an insurance policy, vehicle description, the expiration date of the current insurance policy, an insurance policy number (and company), license plate information, vehicle registration information, contact information for the owner of the vehicle. FIG. 1 shows the insurance company records 102 being separate from the control system 104 and its database 106. This arrangement allows each insurance company to maintain its own records but other arrangements are contemplated as well. For example, the database 106 could include all the policy information currently maintained by insurance companies. This arrangement would allow one central database that can be quickly updated so that the information in the database 106 is as accurate as possible.

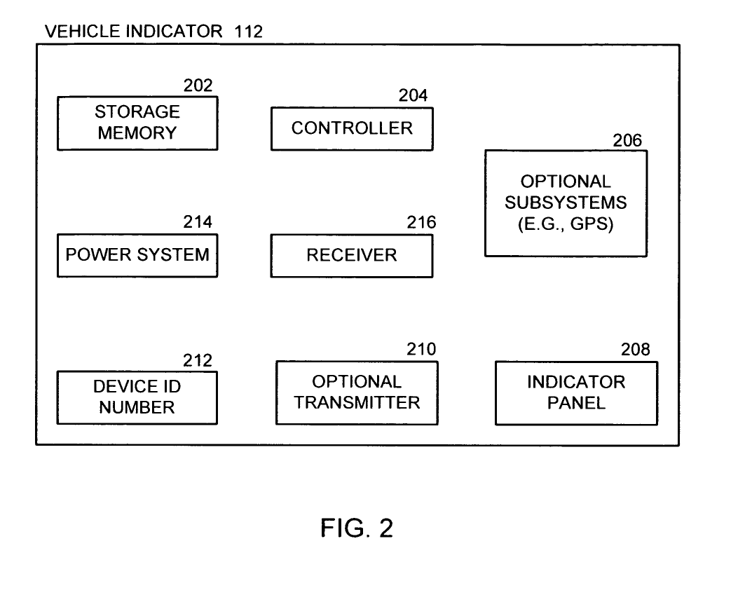

FIG. 2 illustrates a block diagram of an apparatus for verifying insurance in accordance with the principles of the present invention. The vehicle indicator 112 is preferably a small device that easily attaches to the rear of a vehicle near the license plate. In some embodiments, a second indicator may be used as well that attaches near the front of the vehicle. For example, the indicator 112 may have a mounting hole sized to accommodate the screws that attach a vehicle license plate. In other embodiments, the indicator 112 may be a thin device that attaches using adhesive to the surface of the car's body or to the license plate. In yet other embodiments, the indicator 112 may attach to a brake light cover inside or outside the vehicle and, beneficially, derive its power from the wiring to the brake light. In embodiments, where the indicator 112 is attached near the license plate, the indicator 112 may derive its power from the light that illuminates the license plate.

The indicator 112 includes a controller 204, a receiver 216, a device ID number 212, and an indicator panel 208. Working in conjunction with one another, the receiver 216 receives a signal from the satellite 114 or other transmitter and then the controller 204 (e.g., a microcontroller or microprocessor) can determine if the signal is addressed to, or is meant for, its device ID number 212. If so, then the controller 204 determines how to change the indicator panel 208 so that its indication signals conform to instructions received. One of ordinary skill will recognize that the protocols and signal parameters may be selected from a variety of alternatives without departing from the scope of the present invention. For example, the indicator 112 may be required to have a transmitter 210 that can acknowledge proper receipt of a signal and acknowledge performance of the instructions. Because of the additional power usage and difficulty in broadcasting a signal sufficient to reach a satellite, this transmitter 210 may be optional and other signaling protocols implemented.

Also, some type of authentication and verification information may be embedded in the signals received by the indicator 112 to ensure authentic signals are not easily spoofed. The device ID number 212 is sufficient to uniquely identify each vehicle on the road for the foreseeable future and may be hard-coded into the indicator 112 when it is manufactured or may be a value that can be encoded in the indicator 112 at some later time when the indicator 112 is put into use. The power system 214, as mentioned above, may be tied into the electrical system of the car or may be a battery such as, for example, a rechargeable battery that can be recharged through solar energy or the motion of the vehicle. Replaceable batteries are contemplated as well. Additionally, the power system may be configured to power the indicator 112 even when the vehicle is turned off.

The indicator 112 can also include a memory 202 that stores information about the indicator 112 and the vehicle to which it is attached. For example, the license plate number, the expiration date, the insurance carrier, the policy number, the owners name, contact information, and the vehicle identification number (VIN) of the vehicle are all examples of information that may be stored on the indicator 112. This information may be encoded into the memory 202 when the indicator is first registered with a user. For commercial vehicles, other relevant information such as weight limits, highway tax information, and other safety related information may be stored as well. According to some embodiments, the transmitter 210 may be configured to respond to an electronic interrogation device such that the information in the memory 202 may be read from indicator 202. For this purpose, the storage memory 202 may be solid-state memory circuits or may be a magnetic stripe. In this way, a law enforcement officer having the appropriate interrogator may determine pertinent information about the vehicle and its occupants.

Embodiments of the present invention may also include other subsystems 206 as well. These subsystems 206 are not essential to practicing every embodiment of the present invention but may in some instances provide additional benefits. For example, an accelerometer assembly can be configured to indicate that the vehicle was likely involved in a collision. This indication may be in real-time, for example, in order to notify local authorities of an accident in order to assist first responders. Or, it could be just a parameter stored on the indicator 112 that a future car buyer could check to ensure the integrity of the vehicle. Another optional subsystem is a GPS tracking system such that the location of the vehicle can be determined at almost any time. In other words, the indicator 112 can be queried for its position which it determines through an on-board GPS receiver and this position can be relayed back to the control system 103 using the transmitter 210.

The indicator panel 208 may be any of a variety of indicators that are capable of providing the appropriate signals to law enforcement personnel. For example, an LED may be used that when lit is either green or red (of course, two LEDs may be used to accomplish this as well). When the green LED is visible, this indicates that a valid insurance policy is in place on the vehicle associated with this indicator 112. If the red LED is lit, then this indicates that no insurance policy is in place. Alternatively, one LED could be used that when “ON” indicates good insurance and when “OFF” indicates a problem. Thus, if a law enforcement officer observes no LED lit or a red LED lit, then the vehicle may be pulled over under reasonable suspicion of a problem.

Because the indicator 112 can also provide an indication of other items such as, for example, a valid vehicle registration, the indicator panel 208 can have a number of indicator lights as well. Regardless of the ultimate number of indicators present, these indicators are preferably visible or detectable under most outdoor conditions and, therefore, radio frequency indicators may be used in addition to, or in place of, visible LEDs to accommodate very bright conditions or adverse conditions such as rain, snow and fog.

As for construction, the indicator 112 is ruggedly built of a material that can withstand the harsh environment that most vehicles encounter. Many plastics and composite materials are available to choose from that provide indicator 112 with the necessary durability. The indicator 112 is also constructed to reduce the possibility of tampering. For example, the indicator may be constructed of two halves welded along their seam so that they are inseparable. Alternatively, a tamper indicator/disable device may be included so that if an indicator 112 is somehow opened, the green LED (or alternative indicator) is permanently disabled and the indicator 112 can not be reassembled.

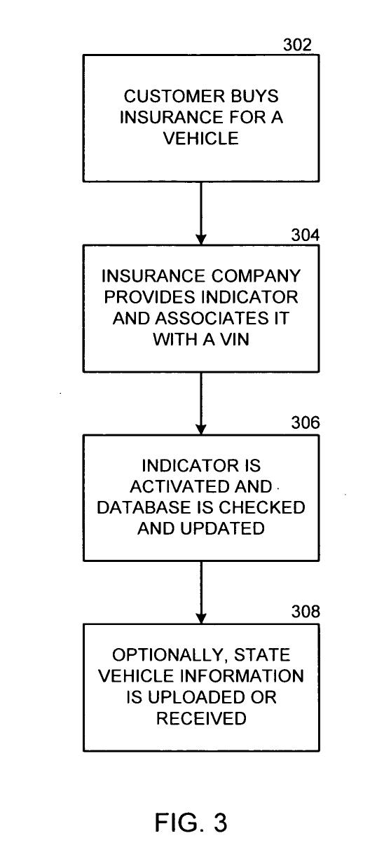

FIG. 3 is a flowchart of a portion of a method of verifying insurance in accordance with the principles of the present invention. In step 302, a customer purchases car insurance for a vehicle from an insurance company (or agent). The company can then provide an indicator device, in step 304, that is associated with the VIN of the vehicle covered under the policy being purchased. One of ordinary skill will recognize that the indicator device may be purchased by a customer and then brought to the insurance company for activation, or the indicator device may be purchased from the insurance company, or provided for free as a part of their service, or provided by the government or other entity to facilitate implementation of the infrastructure of this system.

The insurance company and the control system communicate details of the insurance policy with each other so that the information can be stored in the control system's database and the indicator device can be activated. For example, the insurance company could provide the information through a telephone call so that the data is manually entered at the control system, the data could be provided through a web-based interface (assuming proper credential authentication), or the control system can access the insurance company's computer system to retrieve any new information.

One of the checks that can be performed by the control system is to determine if the VIN is already associated with an active insurance policy. Because having multiple insurance policies on a vehicle can sometimes be used to commit insurance fraud, detecting the existence of an already valid policy may be beneficial. Once all the information, is received at the control system and its database, the indicator device can be activated by an appropriate signal transmitted by the control system using a satellite or other transmitter.

Step 308 is an optional step in that the system may also include information about state registration and license information. This information may also be included in the database of the control system, or is accessible by it, so that it can be used to control the indicator device to also indicate whether the vehicle has a valid registration.

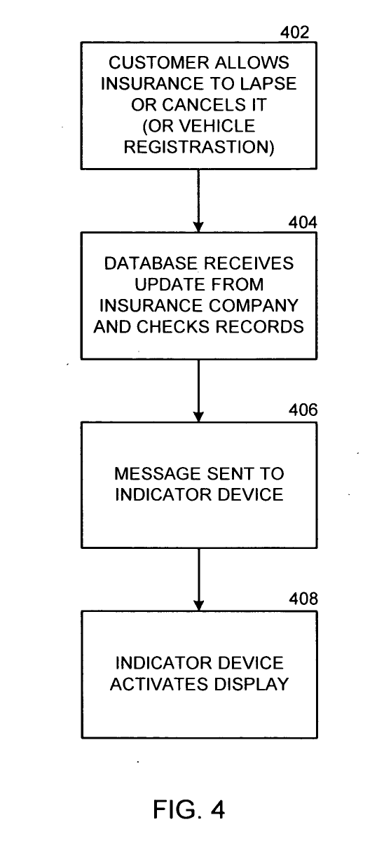

FIG. 4 is a flowchart of a portion of a method of verifying insurance in accordance with the principles of the present invention. In operation, if the customer maintains the insurance for the vehicle, then the control system's database is periodically updated as the policy is renewed so that the indicator device always indicates a valid insurance policy. If however, as in step 402, the customer allows the policy to lapse or cancels the policy altogether, another sequence of events starts to unfold. In step 404, the database receives an update from the insurance company that an insurance policy is no longer in place. This information can be sent individually by the insurance company, can be a batch message for a number of policies, or can be proactively retrieved from the insurance company's computers by the control system. Also, the control system can determine from the expiration dates in the database when a policy lapses. Thus, no explicit communication with an insurance company is needed. The control system then checks in its database to ensure that no replacement policy has been bought for a vehicle having the canceled policy's VIN. If no valid policy is in place for that VIN, then the indicator device associated with that VIN is sent a control message (step 406) that no insurance policy is in place. As a result, in step 408, the indicator device changes its display to indicate that the vehicle is not covered by a valid insurance policy.

In addition to verifying insurance, the system and methods of the present invention also provides secondary benefits because of its centralized storage of relevant information and its methods of reaching vehicles having an indicator device. For example, when law enforcement personnel have information about a vehicle's description, a license plate number, a suspect's name or some combination of those, the control system can be utilized to control the signal output by the indicator device. For example, a wanted person's report, a missing person's report, an amber alert, a stolen vehicle report, or an all-points bulletin can all result in the likely identity of an involved vehicle being known. The vehicle identity information can be used by the control system and its database to send a control signal to the indicator device on the appropriate vehicle. When a law enforcement officer sees a vehicle having the “wrong” signal on the indicator device, it provides another reason to stop that vehicle. Although it adds to the complexity of the indicator device, at least some embodiments contemplate a separate, additional indicator signal that would indicate an “emergency” condition such as the ones mentioned above.

Utilizing the contact information and the policy information in the database, the control system can also be utilized to send periodic messages to vehicle owners regarding policy renewal periods and other information. Text messages, e-mail messages, telephone calls, regular mail, etc. can all be used if appropriate contact information is available.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An apparatus coupled with a vehicle, comprising:
an identification number uniquely identifying the apparatus;
a receiver configured to receive a signal;
a first display indicator configured to indicate, based on the signal, if the vehicle is covered by an insurance policy; and
a controller configured to determine if the signal is associated with the identification number and to control the first display indicator based on the signal.

2. The apparatus of claim 1, wherein the display indicator includes:
a visible light, wherein the visible light is configured to be in a first state if the vehicle is covered by an insurance policy and in a second state if the vehicle is not covered by an insurance policy.

3. The apparatus of claim 2, wherein the first state is a first color and the second state is a second color.

4. The apparatus of claim 2, wherein the first state is “on” and the second state is “off”.

5. The apparatus of claim 1, further comprising:
a second display indicator configured to indicate, based on the signal, if the vehicle has a valid registration; and
wherein the controller is further configured to control the second display indicator based on the signal.

6. The apparatus of claim 1, wherein the display indicator includes:
a transmitter of nonvisible electromagnetic radiation at a first frequency if the vehicle is covered by an insurance policy and at a second frequency if the vehicle is not covered by an insurance policy.

7. The apparatus of claim 1, further comprising:
a position tacking system configured to determine a location of the apparatus.

8. The apparatus of claim 1, wherein the position tracking system includes a global positioning system transceiver.

9. A system for verifying insurance coverage for a vehicle, comprising:
a database storing a plurality of records, each record having an associated identification number, associated insurance policy information and an associated vehicle identification number;
a controller configured to determine from the database whether a particular vehicle is covered by an insurance policy;
the controller further configured to determine the identification number associated with the particular vehicle based on the associated vehicle identification number and to determine a status of the insurance policy associated with the associated vehicle identification number; and
a transmitter configured to communicate a signal to a broadcast transmitter, wherein the signal includes the identification number associated with the associated vehicle identification number and an indication of the status of the insurance policy.

10. The system of claim 9, wherein the broadcast transmitter is a satellite.

11. The system of claim 9, wherein the broadcast transmitter is one of a radio network, a cellular network, a pager network, and a wireless network.

12. The system of claim 9, wherein each of the records further include, respectively:
contact information associated with the vehicle identification number.

13. The system of claim 9, wherein each of the records further include, respectively:
descriptive vehicle information associated with the vehicle identification number.

14. The system of claim 9, wherein each of the records further include, respectively:
vehicle registration information associated with the vehicle identification number.

15. The system of claim 14, wherein the signal further includes the an indication of a status of the associated vehicle registration information.

16. The system of claim 9, further comprising:
a receiver configured to receive updated insurance policy information from one or more insurance companies and update the database based on the updated insurance policy information.

17. A method for verifying insurance coverage for a vehicle, comprising:
storing in a database a plurality of records, each record having an associated identification number, associated insurance policy information and an associated vehicle identification number;
determining from the database whether a particular vehicle is covered by an insurance policy;
determining the identification number associated with the particular vehicle based on the associated vehicle identification number;
determining a status of the insurance policy associated with the associated vehicle identification number; and
transmitting a signal to a broadcast transmitter, wherein the signal includes the identification number associated with the associated vehicle identification number and an indication of the status of the insurance policy.

18. The method of claim 17, wherein the broadcast transmitter is a satellite.

19. The method of claim 17, wherein the signal further includes the an indication of a status of vehicle registration information associated with the particular vehicle.

20. The method of claim 17, wherein the signal further includes an indication of a emergency condition associated with the particular vehicle.
